(19) United States
(12) Patent Application Publication
(10) Pub. No.: US 2004/0186774 A1
(43) Pub. Date: Sep. 23, 2004

(54) Method and system for earning, storing, and using credits in exchange for satisfying predetermined conditions on a website

(76) Inventor: Sung Lee, Englewood, NJ (US)

Correspondence Address: Installinc, 519 8th Avenue 3rd Floor, New York, NY, 10018, US

(21) Appl. No.: 10/757,806

(22) Filed: Jan. 14, 2004

Related U.S. Application Data
(63) Continuation of application No. 09/628,464, filed on Jul. 31, 2000, now abandoned.

(51) Int. Cl. G06F 17/60

(52) U.S. Cl. 705/14

(57) ABSTRACT

A system and method for earning, storing and redeeming credits in exchange for satisfying predetermined conditions on a Website. The predetermined conditions may be any of a variety of acts that can be conducted via a Website, including viewing and/or listening to advertisements, movie segments, music, spoken word, or promotional material. The predetermined conditions may also require the user to respond to an opinion or demographic survey, or to beta test a software application or game, or to interact in some other way with material presented via the Website. By directly rewarding the satisfaction of the predetermined conditions, the Website operator can incentivize greater participation in the conduct on which the fees paid by sponsors of the Website are based.

Credits are earned for satisfying the predetermined condition and are added to the user's account. The balance of unused credits in the account is maintained and displayed to the user when he or she visits the Website. This balance of unused credits is available for use immediately after it is posted. However, the user does not have to use the earned credits in any particular time period. The user may accumulate credits in his account until such time as he or she is ready to use them. The enduring nature of these credits enhances their value to users, and increases their motivation to satisfy the predetermined conditions.

Credits can be redeemed for total or partial discounts on services. In one embodiment, credits are redeemable for time segments of long distance telephone service. Such service may be supplied over the Internet or from phone-to-phone. Other services for which credits can be redeemable include access to movies, televised events or presentations, music, and games. In other embodiments, credits are redeemable for partial or total discounts on goods. The flexible nature of the credits further enhances their value and incentive power to users of the Website.

### FIELD OF THE INVENTION

This invention relates to systems and methods for earning credits redeemable for a good or service, storing a record of the balance of these credits, and expending these credits to receive a partial or total discount for the good or service.

### BACKGROUND OF THE INVENTION

One way for a commercial Website operator to generate revenue is through fees for advertisements carried on the Website. Advertisers who seek exposure on the Website pay the Website operator for the right to display their advertisements. Hopefully, such exposure to the users of the Website stimulates demand for the goods or services advertised.

The fees that a Website operator may charge for the right to display advertising can be a function of several different factors. Many Website operators have based advertising fees on the quantity of viewers of the advertisements. Since many Websites rotate different advertisements on the viewer's screen over time, the average number of viewers who view an advertisement is a function of the traffic through the Website and the average period of time spent viewing the Website. This scheme generally relies on quality content of the Website to attract viewers and hold their attention for as long as possible. The content should also be regularly updated to generate repeat viewer traffic over time. The generation and constant updating of Website content that consistently draws traffic and sustains interest can be expensive for a Website operator.

The degree to which an advertisement is fully exploited by viewers of a Website, by accessing features from the first displayed panel is measured as the “click-through rate.” The proliferation of advertisements on Websites has caused many viewers to disregard all Website advertising, resulting in low click-through rates. Click-through rates of less than 1% have been reported. Some advertisers have come to view click-through rates, rather than measures of Website traffic, viewing time, or average number of viewers, as the key determinant in the fees they are willing to pay for Website advertising. These advertisers demand a more performance-based approach.

An alternate approach is to measure the amount of time the Website viewers spend viewing or otherwise interacting with the advertisement itself, as opposed to the overall Website. Many Website advertisements feature multiple levels or “pages,” viewer information entry pages, or multimedia effects. Advertisers who run such ads are likely to feel that demand will not be sufficiently stimulated to convert enough viewers into customers unless the viewers fully experience the ads.

In response, Website operators have had to find creative ways to increase click-through rates. One alternate approach that has been used by Website operators with some success is that of directly rewarding viewers of the Website for clicking-through the advertisement. For example, a viewer can earn a reward for fully clicking through the Website of a company on whose advertisement they have provided an appropriate link. Alternatively, viewers might be rewarded for activating and experiencing an audiovisual presentation accessible through the advertisement.

For this scheme to be effective, Website operators must offer rewards that viewers value. The value of a reward is enhanced by the degree to which it is free from constraints on its applicability. Discounts applicable to a single product or service, or provider thereof, are less valuable than those not so limited. Constraints as to time or place and conditions of use make rewards less valuable. Rewards that can accumulate with time and can be applied at any time in the future from a multitude of locations would be particularly valuable.

The rewards can come in many forms. Some Websites feature frequent flier points that can be redeemed by airlines toward the purchase price of airline tickets. Other Websites offer discounts on products or services. A variety of Websites offer long distance telephone service time. Typically such a Website will reward a viewer with a certain quantity of long distance telephone service time in exchange for viewing advertisements for a second period of time. The long distance telephone service offered by many of these services is “Internet service,” i.e., the call is placed by the viewer using a telephone headset or other communication device that is connected to the viewer's personal computer, or other interface device. In some instances, the intended recipient of the telephone call must be connected to the Internet through his personal computer, or interface device, similarly equipped with a telephone headset or other communication device. In other cases, the call may be placed to a regular telephone, and there is no need for the recipient to be “online” and so accoutered. The aural quality of those calls that are transmitted via the Internet can be poor relative to that experienced over a traditional telephone network.

### SUMMARY OF THE INVENTION

In one aspect, the invention features a method for rewarding a user of a Website, said method comprising the steps of: awarding at least one credit to the user of the Website when the user satisfies a predetermined condition; adding said at least one credit to a credit balance in an account, said account being assigned to the user; storing said credit balance in a memory; and, allowing the user to exchange a quantity of credits for a predetermined number of minutes of telephone service that can be utilized over a standard telephone system.

In preferred embodiments, the predetermined condition can be viewing at least one advertisement on said Website, responding to a survey on said Website, listening to at least one audio presentation, testing a software application, or otherwise interacting with material presented on said Website.

The credits may also be redeemable to obtain access to an audiovisual presentation, access to at least one audio selection, access to at least one software game application, or a discount on the price of at least one good.

In still another aspect the invention features a system for rewarding a user of a Website, said system comprising: a memory having program code stored therein and for storing information concerning a plurality of users; a processor connected to said memory for carrying out instructions in accordance with said stored program code; and a communications device connected to said processor for allowing said processor to communicate with other devices using the Internet; wherein said program code, when executed by said processor, causes said processor to perform the steps of: awarding at least one credit to the user of the Website when the user satisfies a predetermined condition; adding said at least one credit to a credit balance in an account, said account being assigned to the user; storing said credit balance in a memory; and, allowing the user to exchange a quantity of credits for a predetermined number of minutes of telephone service that can be utilized over a standard telephone system.

In still another aspect the invention features an article of manufacture comprising a computer readable medium having computer usable program code embodied therein, said computer usable program code containing executable instructions that, when executed, cause a computer to perform the steps of: awarding at least one credit to the user of the Website when the user satisfies a predetermined condition; adding said at least one credit to a credit balance in an account, said account being assigned to the user; storing said credit balance in a memory; and, allowing the user to exchange a quantity of credits for a predetermined number of minutes of telephone service that can be utilized over a standard telephone system.

### BRIEF DESCRIPTION OF THE DRAWINGS

FIG. 1 is a schematic diagram of a system according to one embodiment of the invention.

FIGS. 2, 3, and 4 are flow diagrams illustrating a number of steps carried out by a server in FIG. 1.

FIGS. 5 and 6 are schematic layouts of pages of the Website.

### DETAILED DESCRIPTION OF PREFERRED EMBODIMENTS

In certain preferred embodiments, the invention features a Website that: (1) rewards a viewer for satisfying a predetermined condition on the Website with credits, (2) records the earned credits in the viewer's account, and (3) allows the viewer to redeem the credits for minutes of telephone service, access to movies, music, software, or a partial or total discount of the purchase price of a good by expending unused credits at any point in time after the credits have been earned. These and other features, as discussed below, encourage viewers to view advertisements, sample movies or musical selections, test software or games, or respond to surveys placed on a Website, and thereby enhance revenues earned by the Website operator for posting these materials and otherwise eliciting the desired responses from users.

The system rewards users of the Website for satisfying a condition by awarding credits. The condition is predetermined by the sponsor of the offer of the credits. For example, an advertiser may require that the viewer watch a video presentation. The presentation may be an advertisement or an informational summary for a product or service and may or may not be accompanied by audio. Alternatively, the viewer may be required to listen to a set of musical selections, or view clips from a motion picture. The conditions may require the user, after having viewed an advertisement or listened to musical selections, to respond to a survey of opinions or to a set of questions regarding his demographic status. Alternatively, the condition may consist of the completion of a survey that is not related to any prior presentation. The condition could also consist of a requirement that the user participate in a “beta” test of a software application. The software application could be a game or a utility. Generally, the predetermined condition can be any requirement that the sponsor can offer a user and that the user can satisfy through the Website.

The offer may be explicit as to exactly what is required of the user, e.g., listen to a two-minute collection of recently released musical selections, try out a new software game for three minutes, or watch and listen to ninety seconds of the latest Hollywood film. In addition, the reward for satisfying the condition is clearly communicated to the user prior to the initiation of the satisfaction process. Rewards may consist of credits that are redeemable for any goods or services. The credits may be redeemable against the total purchase price or any portion thereof.

In certain preferred embodiments, the credits consist of the right to use long distance telephone service for discrete periods of time, e.g., minutes. This long distance telephone service is enabled over a standard telephone system, i.e., a system comprising standard telephone equipment at both the originating and receiving ends of the telephone call, interconnected by a standard telephone network. This is sometimes referred to as “phone-to-phone” service. The user of these credits is not limited to telephone service over the world wide Web, in which either the originating or the receiving party must connect to the Web through an appropriate interface device.

In other embodiments, the credits may be redeemable for access to movies or other audiovisual presentations, music or other audio presentations or utility or gaming software applications. By directly linking the user activity desired by the sponsor to the reward of the user, the performance of the desired activities is maximized, and consequently, so are revenues to the Website operator based on fees paid by sponsors.

The credits are automatically awarded to users who satisfy the predetermined conditions. Each user registers with the Website. In so doing, an account is provided for the user. In the account, a current balance of credits is maintained by adding newly earned credits and debiting credits as they are expended for goods or services. In this way, the current quantity of credits in the user's account is updated after each transaction by the user. Since the current balance is always maintained, the user is free to earn credits and to save them until he or she is ready to expend them. This means that the satisfaction of the predetermined requirement does not have to be immediately followed by the expenditure of the credits earned. The credits are enduring and may be used at the discretion of the user at the time of his or her choosing, thus enhancing their value and incentive strength to the user.

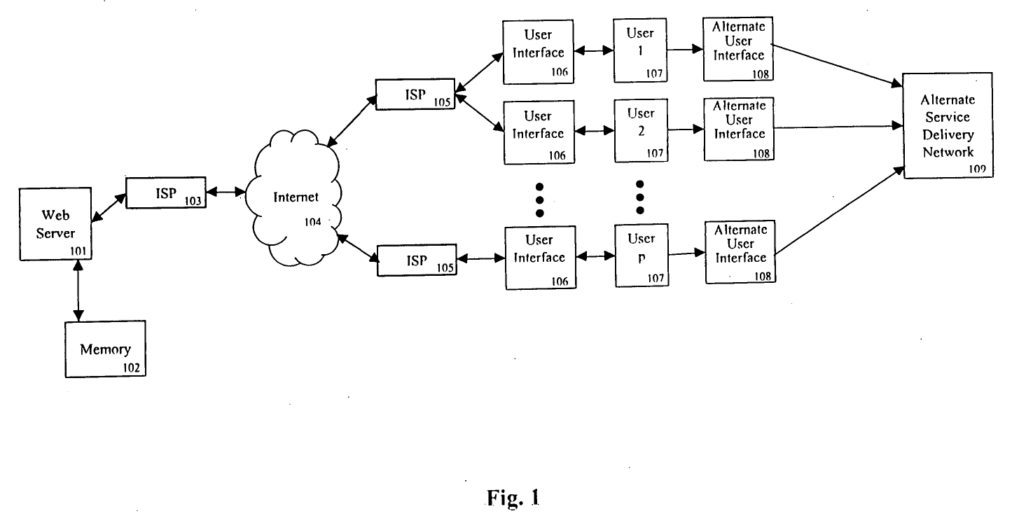

A system in accordance with an exemplary embodiment of the invention is shown in FIG. 1. A Website is hosted on a Web Server 101 which is connected to Internet 104 via an Internet service provider (ISP) 103. Web Server 101 is also connected to a Memory 102 used to store a variety of information, described below. Users₁₋ₚ 107 are connected to Internet 104 via User Interfaces 106 and ISP 105. As shown in FIG. 1, the ISP connecting any one user to the Internet does not have to be the same as that used to connect any other user or the Web Server 101 to the Internet.

As is well known, the User Interface may be comprised of a personal computer (PC), a personal digital assistant (PDA), a digital telephone or any of a variety of Internet communication devices commonly known as “network appliances.” For purposes of the preferred embodiment it is assumed that a display is used to present information to each user, but it should be understood that information may be presented to the users by an audio signal, a Braille interface or any other suitable user interface.

User Interfaces 106 and Web Server 101 shown in FIG. 1 are connected to the respective ISP's 103 through any suitable means, such as a cable connection, wireless communication, standard telephone lines or combinations of these or other communications media. Appropriate software resides in a memory associated with each server and user processor to enable communication with its associated ISP. For example, the user processors will typically use an Internet browser, such as Netscape Navigator.

The ISPs are well known to those of skill in the art and often comprise local area networks that are wired directly to the Internet by means of a dedicated port called a T-connection. America Online (AOL) and UUNET are well known ISPs. Similarly, web servers are well known. Web Servers host Websites and receive and respond to requests for pages of information from those sites.

Web Server 101 comprises a receiver to receive requests from the Internet, a transmitter to transmit information to the Internet and a suitable processor. Memory 102 can be implemented using various combinations of well-known computer memory devices.

In the preferred embodiment, a user 107 accesses the Website operator's Web Server 101 through the Internet and the respective ISP's. This is done by issuing appropriate commands through an associated User Interface 106, which transmits the commands to the associated ISP 105, which in turn, transmits the command to the appropriate Web Server 101 through the Internet 104 and the Web Server's ISP 103. The formatting required to transmit the instructions to the correct ISP is done using standard protocols and is well known to those skilled in the art.

In certain embodiments of the invention, users will redeem credits for services, and these services will be delivered through the Internet. In these embodiments, the physical aspects of the invention are described by item numbers 101 through 107. However, in alternate embodiments, the service will not be provided through the Internet. In some of these embodiments, an Alternate User Interface 108 and an Alternative Service Delivery Network 109 may be included within the scope of the invention. The Alternate User Interface and Service Delivery Network may be comprised of a telephone and a long distance telephone service provider, a television and a cable or satellite transmission system, or any other compatible pairing of service interface and delivery network systems suited to delivery of the service for which credits are redeemed.

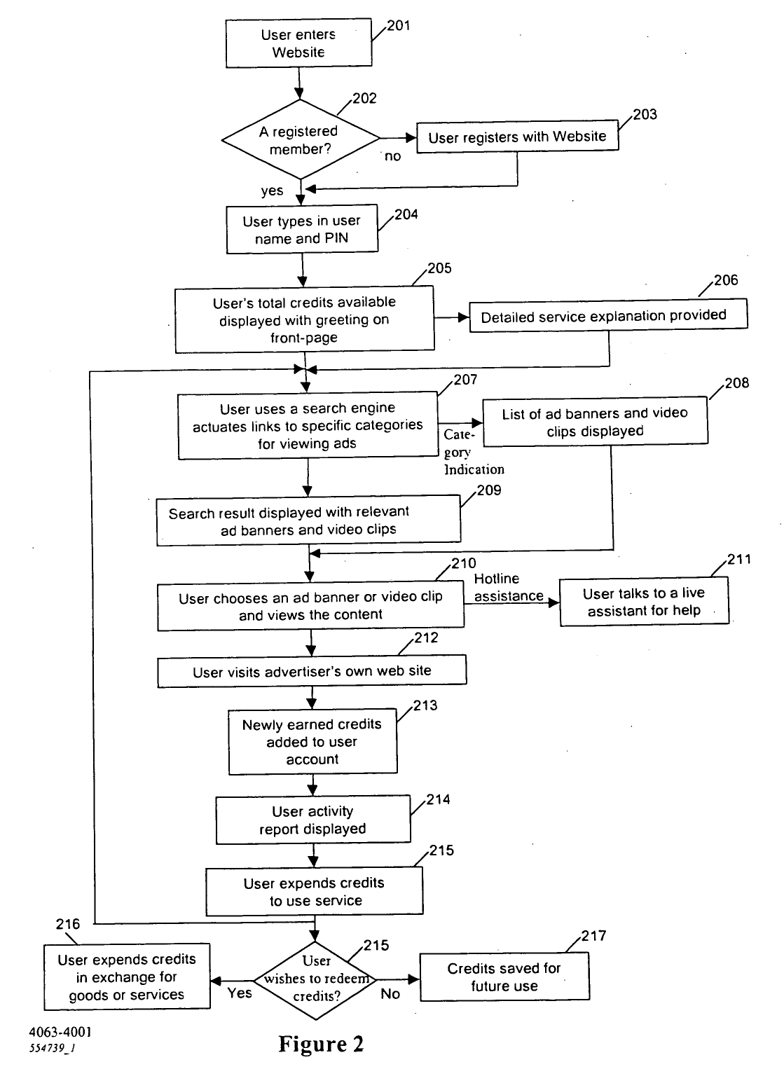

Certain features of one embodiment of the process implemented by Web Server 101 are illustrated in FIG. 2. In this embodiment, the predetermined condition that must be satisfied for the user to earn credits is the viewing of advertisements (ads). It should be understood that this is merely one aspect of the invention, and that many other options exist for predetermined conditions.

The process starts when a user accesses the home page of the Website (step 201). If the user is a registered member (step 202), the user enters a user name and a Personal Identification Number (PIN) (step 204). If the user is not a registered member, he or she must register with the Website before continuing (step 203).

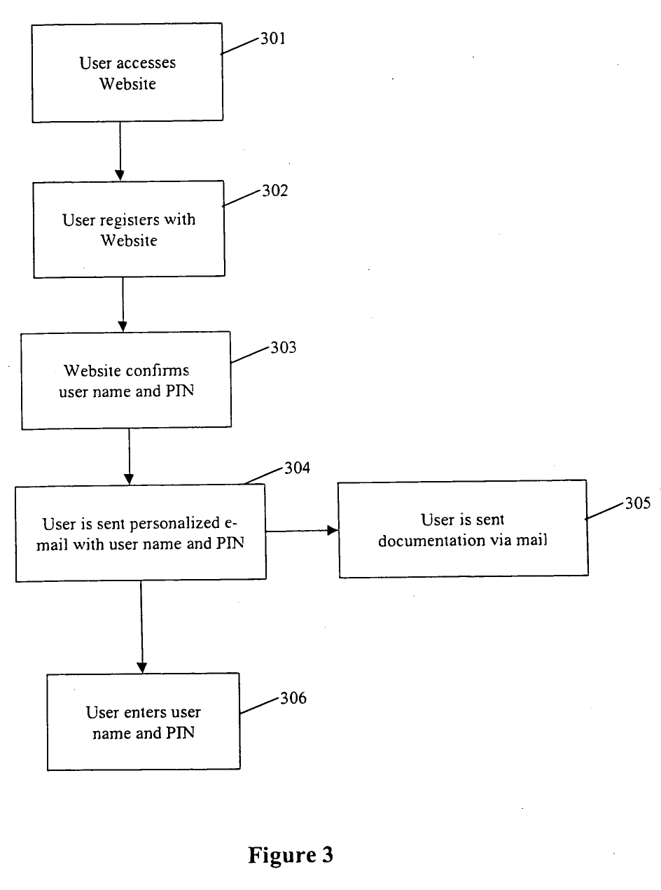

The process of registration is illustrated in FIG. 3. After accessing the Website (step 301), the user registers by entering standard information regarding his identity, address, and contact information (step 302). The user also enters a user name and a PIN. The Website prompts the user to confirm the user name and PIN by reentering them (step 303). After the information has been appropriately processed by the Web Server 101 and stored in Memory 102, the user is sent a personalized electronic mail message (email) confirming the user name and PIN (step 304). The user will be sent a set of documentation describing the functioning of the Website via mail (step 305). Having registered, the user can now enter his user name and PIN (step 306), and proceed to use the Website.

Returning to FIG. 2, upon receiving the user name and PIN, the Website displays a greeting along with the user's total current balance of credits (step 205). A detailed explanation of services available through the Website is made available (step 206). The user can now use the functionalities available to him on the Website (step 207). The user can choose a specific category of ads to view. The Website will then display a list of ads associated with that category (step 208). Alternatively, the user can use the search engine by entering a search term and initiating the search. When the search engine has completed the search, the results are displayed along with relevant ads (step 209). Whether the user employs the category click option or the search engine option, the Website will display a set of ads that are responsive to his entries.

The user now indicates the particular ads he or she wishes to view (step 210). The ads contain links to the advertisers' Websites, where further information can be found. The user has the option of actuating these links to access those Websites (step 212). In the embodiment of the invention described in FIG. 2, the user's acts of viewing an ad and viewing an advertiser's Website each cause the user to earn credits. As the credits are earned, they are added to the current balance of total credits (step 213) and this balance is displayed on the Website (step 214). At this point the user may choose to earn more points by selecting more ads to view (step 207). Alternatively, the user has the option of redeeming credits (step 216), or leaving the Website and saving the balance of earned credits for future use (step 217).

As discussed above, once the user has earned credits such that his account reflects a positive balance of credits, the user can redeem any or all of the balance of credits. Various embodiments of this invention encompass different goods and services for which credits may be redeemed.

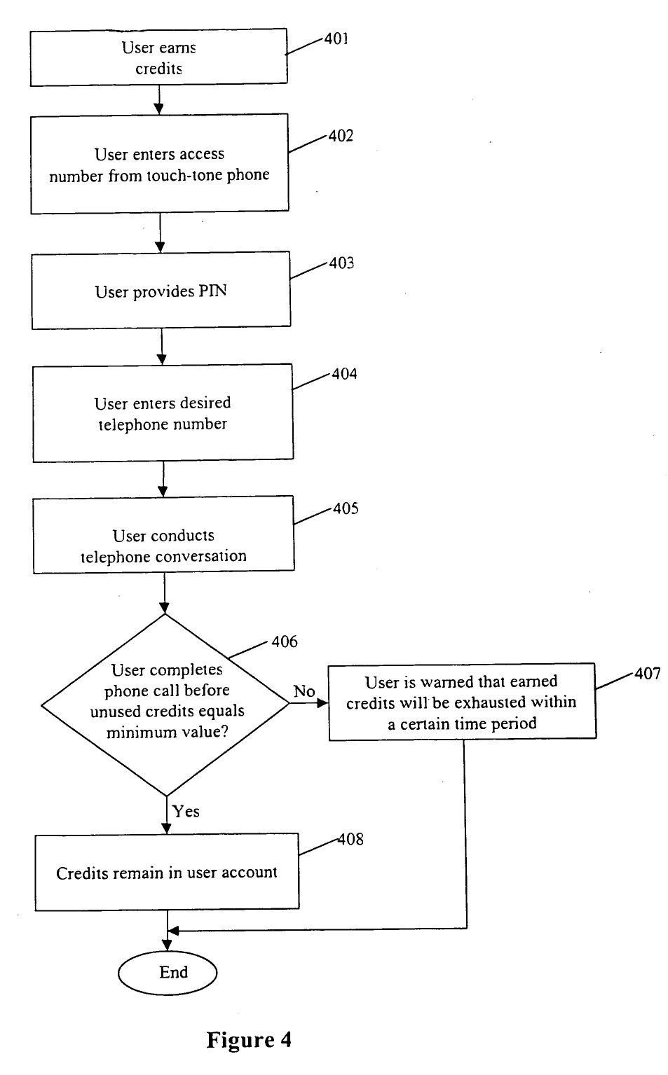

In one set of embodiments, credits are redeemable for long distance telephone service. In these embodiments, the Alternate User Interface 108 and the Alternate Service Delivery Network 109 are the user's telephone device and a long distance telephone service provider, respectively, in FIG. 1. FIG. 4 illustrates some of the important aspects of these embodiments. After having earned credits as described above (step 401), the user utilizes the touch-tone keypad on the telephone to enter an access number (step 402). Next, the user enters the PIN (step 403). The user's PIN is checked against the user name, and if the two match, the user is granted access to the long distance telephone service. The user enters the desired telephone number (step 404) and proceeds with the telephone conversation (step 405). Each credit is worth a certain amount of time on the long distance telephone call. For example, each credit could be worth one minute of long distance telephone service. As the user spends time using the long distance telephone service, the balance of credits is continually consumed. If and when the balance of credits falls to a value that is equivalent to a certain minimum time value, the user is given a warning that his credits will expire within that time period if he or she does not terminate the phone call before that time has expired (step 407). For example, if one credit were equal to one minute of long distance telephone service, the user would receive the message, “Your telephone call will terminate in one minute.” If the user terminates the telephone call prior to consuming his credits, the outstanding balance of credits remains in his account for future use (step 408).

In other embodiments, the service for which credits are redeemable is access to movies, music, televised events or presentations. Unlike telephone calls, these services are for discrete periods of time not controlled by the user and may have measures of value that are independent of their time durations. Therefore, each of these services is valued in predetermined quantities of credits, and constitutes credit-denominated “costs.” For example, viewing the movie “Gone With the Wind” could cost a 65 credits, listening to a Pavarotti CD could cost 25 credits, and watching the a televised wrestling match could cost 8 credits. In each embodiment, the user provides proof of his identity by supplying a user name and PIN. The user then indicates his selection, is informed of the cost and is asked whether he or she wishes to proceed with the redemption transaction. If the user consents, the user's credit balance is checked to determine that it is sufficient for the cost of the chosen service, and if it is, he or she is provided with access to the service.

Other embodiments are directed to the redemption of earned credits toward the acquisition of goods. In a manner similar to that described above, the Website distribution control center that provides various offers to exchange credits for discounts on specific goods, or for the goods themselves. The user is informed of the exchange offers and the user's account balance is checked prior to finalizing the transaction. The discount can take the form of a voucher to be presented at the actual purchase of the good, or a promise to make a payment to the user after proof of purchase is presented.

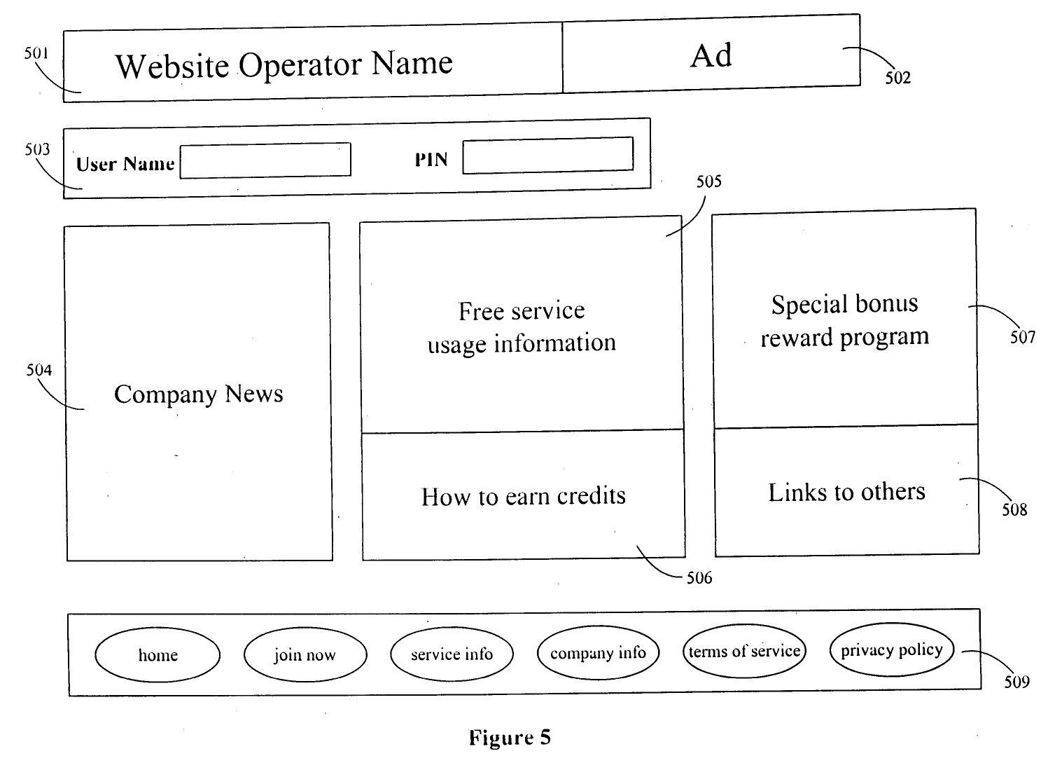

The Website consists of one or more Web pages that the user views on the User Interface 106. An example of a layout of a homepage for the Website is shown in FIG. 5. The Website Operator Provider Name is prominently displayed (501), as are paid advertisements (502). To log in to the Website, the user enters a user name and PIN in the indicated boxes (503). The homepage features news on the service provider (504), information on how to use the Website (505), how to earn credits (506), and on bonus award programs (507). Links to other Websites are also provided (508). A set of “navigation buttons” is provided to allow the user to quickly maneuver through the Website (509). They provide quick access to information such as that regarding membership, use of the Website, the company that operates the Website, terms of service and the privacy policy. The same set of navigation buttons appears on each page of the Website.

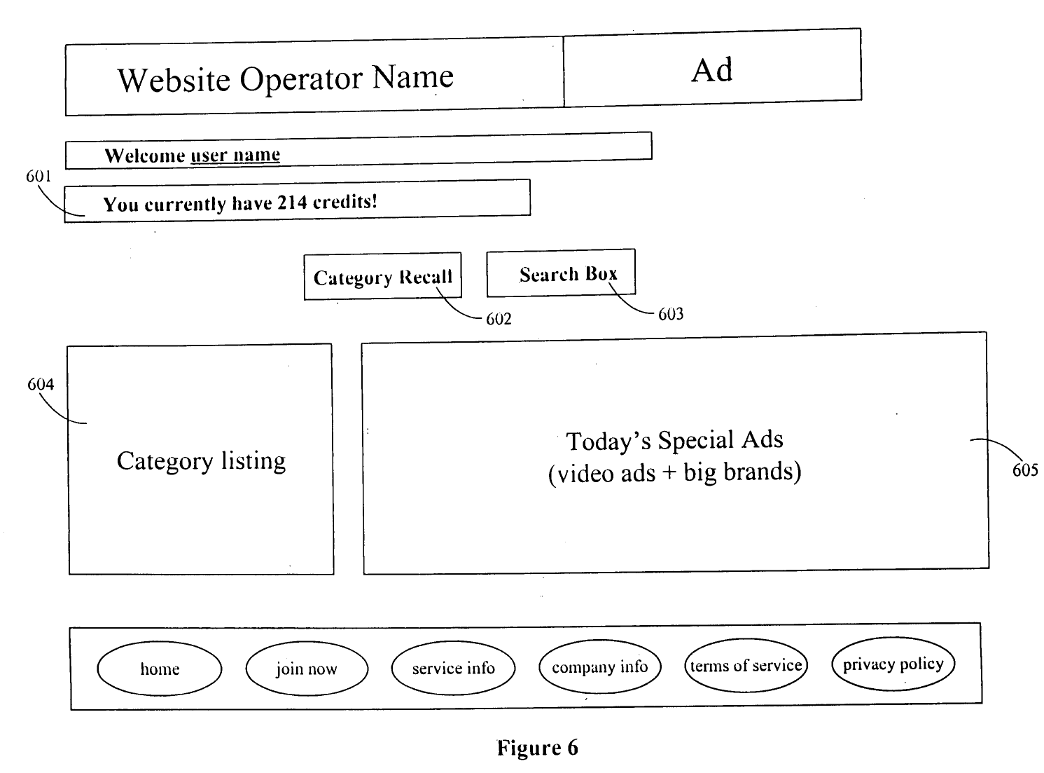

FIG. 6 shows an example of a layout of another page of the Website. The user's current balance of unused credits is displayed (601). A category listing of ads available for viewing is displayed (604). The user may choose a category from among this listing and enter it in the appropriate box (602). Alternatively, the user can enter a search word in the search box to generate a listing of ads of interest (603). Featured ads are also prominently displayed (605).

Many other embodiments are within the spirit of the invention and the preceding is intended only by way of example, and should not be construed to limit the invention to any of the specific details disclosed above.

1. A method for rewarding a user of a Website, said method comprising the steps of:
awarding at least one credit to the user of the Website when the user satisfies a predetermined condition;
adding said at least one credit to a credit balance in an account, said account being assigned to the user;
storing said credit balance in a memory; and
allowing the user to exchange a quantity of credits for a predetermined number of minutes of telephone service that can be utilized over a standard telephone system.

2. The method of claim 1 wherein said predetermined condition comprises viewing at least one advertisement on said Website.

3. The method of claim 1 wherein said predetermined condition comprises responding to a survey on said Website.

4. The method of claim 1 wherein said predetermined condition comprises listening to at least one audio presentation.

5. The method of claim 1 wherein said predetermined condition comprises testing a software application.

6. The method of claim 1 wherein said predetermined condition comprises interacting with material presented on said Website.

7. The method of claim 1 wherein said credits may be redeemed to obtain access to an audiovisual presentation.

8. The method of claim 1 wherein said credits may be redeemed to obtain access to at least one audio selection.

9. The method of claim 1 wherein said credits may be redeemed to obtain access to at least one software game application.

10. The method of claim 1 wherein said credits may be redeemed to obtain a discount on the price of at least one good.

11. A system for rewarding a user of a Website, said system comprising:
a memory having program code stored therein and for storing information concerning a plurality of users;
a processor connected to said memory for carrying out instructions in accordance with said stored program code; and
a communications device connected to said processor for allowing said processor to communicate with other devices using the Internet;
wherein said program code, when executed by said processor, causes said processor to perform the steps of:
awarding at least one credit to the user of the Website when the user satisfies a predetermined condition;
adding at least one credit to a credit balance in an account, said account being assigned to the user;
storing said credit balance in the memory; and
allowing the user to exchange a quantity of credits for a predetermined number of minutes of telephone service that can be utilized over a standard telephone system.

12. The system of claim 11 wherein said predetermined condition comprises viewing at least one advertisement on said Website.

13. The system of claim 11 wherein said predetermined condition comprises responding to a survey on said Website.

14. The system of claim 11 wherein said predetermined condition comprises listening to at least one audio presentation.

15. The system of claim 11 wherein said predetermined condition comprises testing a software application.

16. The system of claim 111 wherein said predetermined condition comprises interacting with material presented on said Website.

17. The system of claim 11 wherein said credits may be redeemed to obtain access to an audiovisual presentation.

18. The system of claim 11 wherein said credits may be redeemed to obtain access to at least one audio selection.

19. The system of claim 11 wherein said credits may be redeemed to obtain access to at least one software game application.

20. The system of claim 11 wherein said credits may be redeemed to obtain a discount on the price of at least one good.

21. An article of manufacture comprising a computer readable medium having computer usable program code embodied therein, said computer usable program code containing executable instructions that, when executed, cause a computer to perform the steps of:
awarding at least one credit to the user of the Website when the user satisfies a predetermined condition;
adding at least one credit to a credit balance in an account, said account being assigned to the user;
storing said credit balance in a memory; and
allowing the user to exchange a quantity of credits for a predetermined number of minutes of telephone service that can be utilized over standard telephone equipment.

22. The article of manufacture of claim 21 wherein said predetermined condition comprises viewing at least one advertisement on said Website.

23. The article of manufacture of claim 21 wherein said predetermined condition comprises responding to a survey on said Website.

24. The article of manufacture of claim 21 wherein said predetermined condition comprises listening to at least one audio presentation.

25. The article of manufacture of claim 21 wherein said predetermined condition comprises testing a software application.

26. The article of manufacture of claim 21 wherein said predetermined condition comprises interacting with material presented on said Website.

27. The article of manufacture of claim 21 wherein said credits may be redeemed to obtain access to an audiovisual presentation.

28. The article of manufacture of claim 21 wherein said credits may be redeemed to obtain access to at least one audio selection.

29. The article of manufacture of claim 21 wherein said credits may be redeemed to obtain access to at least one software game application.

30. The article of manufacture of claim 21 wherein said credits may be redeemed to obtain a discount on the price of at least one good.
